(19) United States
(12) Patent Application Publication
(10) Pub. No.: US 2026/0359876 A1
(43) Pub. Date: Nov. 12, 2026

(54) COMPUTER-IMPLEMENTED METHOD AND SYSTEM FOR VALUE-DRIVEN COMMERCE PLATFORM

(71) Applicant: Jillian Bichanich, Greenwich, CT (US)

(72) Inventor: Jillian Bichanich, Greenwich, CT (US)

(21) Appl. No.: 19/202,005

(22) Filed: May 8, 2025

(51) Int. Cl. G06Q 30/0601; G06F 3/023; G06F 16/9535

(52) U.S. Cl. CPC G06Q 30/0631; G06F 3/0236; G06F 16/9535

(57) ABSTRACT

A computer-implemented method and system for a value-driven commerce platform that connects consumers with businesses aligned with their personal values. The system stores user profiles containing interests, causes, and social connections, as well as business profiles containing descriptive attributes and claimed value-based characteristics (e.g., women-owned, sustainable). A machine learning-based recommendation engine matches users to businesses by analyzing alignment between user preferences and business attributes, and presents a ranked list of suggested businesses via a user interface. Verified badges indicate authentic attributes (such as a confirmed minority-owned status) to build trust. Users can follow (“Pocket”) businesses to receive updates and offers, and earn incentives like badges or discounts for engaging in cause-aligned shopping. In some embodiments, an AI personal shopping assistant monitors user behavior and provides personalized recommendations, budgetary guidance, and impact tracking (e.g., showing what percentage of spending supports selected causes).

### BACKGROUND

### Field of the Invention

The present invention relates generally to the field of computer-implemented methods and systems for facilitating consumer commerce and social engagement based on shared values. More specifically, the invention pertains to a value-driven commerce platform that enables consumers to discover and interact with businesses aligned with their personal values (such as social or environmental causes) by storing profile data, validating business attributes, and providing personalized, AI-driven recommendations, AI-powered personal shopping assistance functionalities, and automated transaction capabilities.

Unlike traditional commerce platforms that facilitate transactions for a curated selection of products, the present invention provides an open and inclusive discovery system that allows businesses of all types to be found based on their alignment with user values, thereby enabling massive visibility and economic impact for small and underrepresented businesses.

### Description of the Related Art

In the modern consumer market, individuals increasingly seek to “vote with their dollars” by supporting businesses that reflect their personal ethics and values. For example, ethical shoppers may prefer to patronize women-owned businesses, environmentally sustainable companies, or brands that support charitable causes. However, identifying and engaging with such value-aligned businesses can be challenging. Existing commerce platforms focus primarily on direct transactions, curated product listings, or limited selections of businesses. While some platforms offer ethical purchasing categories, they often lack a broad, value-aligned discovery mechanism that spans all business types. Furthermore, recommendation systems today focus on product-based consumption rather than systemic economic shifts that empower values-based spending at scale. The present invention solves this problem by integrating broad discovery, social influence, and AI-driven behavior tracking to shift consumer habits toward businesses aligned with their values.

Various systems and methods have been proposed in the prior art to connect users with content or commerce options based on preferences. For example, U.S. Pat. No. 8,326,683 to Cordeiro discloses a personalized consumer-to-business matchmaking system that generates a match score between a business and a consumer based on individual traits, requirements, and profiles of the business, the consumer, and reviewers. While this approach personalizes recommendations for a consumer, it focuses on matching for a specific transaction context (using user review inputs and trait compatibility) rather than creating an ongoing value-driven social commerce experience. It does not address features such as providing visibility into friend-supported businesses, verified ethical credentials of businesses, or AI-driven purchase assistance. Other existing platforms (for instance, general social networks or shopping sites) may allow users to follow brands or see product recommendations, but they typically lack an integrated emphasis on user values and cause-related attributes. They also often include direct messaging or generic advertising, which can distract from or even undermine a purely values-focused shopping experience. For instance, current platforms do not automatically remind users of upcoming events (such as birthdays or anniversaries) by suggesting value-aligned gifts, nor do they assist users in setting and tracking personal goals for ethical spending.

Accordingly, no existing solution fully addresses the need for a dedicated platform that combines value-based business discovery, social proof through friends (without direct messaging), verification of business attributes, and AI-driven purchase automation. The present invention fills this gap by providing a unified system that empowers consumers to easily find and support businesses that align with their values, while offering businesses a way to reach value-motivated customers in a trusted environment.

The present invention fills this gap by introducing an integrated platform with novel combinations of features that embed ethical decision-making into everyday spending through intelligent automation and social commerce.

### SUMMARY OF THE INVENTION

This summary is provided to introduce a selection of concepts, in a simplified format, that are further described in the detailed description of the invention. This summary is neither intended to identify key or essential inventive concepts of the invention nor is it intended for determining the scope of the invention.

The present invention is a computer-implemented method and system for a value-driven commerce platform that connects consumers with businesses aligned with their personal values. The platform stores user profiles containing information such as each user's interests, causes, and social connections, as well as business profiles containing descriptive attributes and claimed value-based characteristics (e.g., women-owned, sustainable). The method involves matching or recommending businesses to users based on value alignment. The system utilizes a machine learning-based recommendation engine that analyzes the alignment between a user's preferences and the businesses'attributes, producing a relevance score or ranking for potential matches. These recommended businesses are then presented to the user via a user interface as a ranked list of suggestions. Verified badges on business profiles indicate authentic value-based attributes (such as a confirmed minority-owned status), thereby building trust that the businesses genuinely uphold the values they claim.

The method involves matching or recommending businesses to users based on value alignment. The system receives input from a user (for instance, a search for a type of business or a selection of a cause they care about) and uses the stored profiles to identify businesses that meet the criteria or align with the user's values. A recommendation engine, which in some embodiments utilizes a machine learning model trained on historical user behavior and feedback, calculates relevance or “alignment scores” between the user and various businesses. The businesses are then rank-ordered or filtered according to these scores and the user's context (such as location or categories of interest). The platform presents the user with a personalized list of recommended businesses, each highlighted with the business's key value attributes and any social proof (for example, indicators if the user's friends follow that business). This consumer-driven discovery process empowers the user to find companies that match their principles in an efficient, engaging way.

Once a user identifies a business of interest, the platform enables them to “Pocket” the business (i.e., follow or save it). By following a business, the user creates a subscription to that business's updates on the platform. The system stores this connection and thereafter presents the user with notifications or new content whenever the followed business has news, offers, or events (for example, a discount on sustainable products or an announcement about a charitable initiative). The user interface does not include open-ended messaging between users and businesses; instead, interaction is driven by these follows and updates, maintaining a focused channel for value-based engagement. The platform incentivizes engagement by awarding badges, loyalty points, or discounts to users for supporting value-aligned businesses. For instance, a user might earn a “Local Supporter” badge after following and shopping at several local small businesses, or receive a coupon after making their first purchase from a minority-owned business through the platform. These rewards not only encourage repeat use but also celebrate the user's impact, reinforcing the core values of the platform.

In some embodiments, the platform incorporates social networking features tailored to commerce and values. Users can connect with or “Pocket” (follow) other users (such as friends or like-minded shoppers) to share and indirectly discover value-driven content. The social aspect is implemented through activity updates and profile information. For example, the platform may display to a user the causes and businesses their friends have recently supported. Notably, the system does not include direct messaging between users, which keeps interactions focused and reduces noise. Instead, communication is facilitated through sharing of updates, reviews, and the visibility of friends'activities (e.g., seeing that a friend earned a “Climate Champion” badge or started following a new eco-friendly brand). Businesses can also accrue followers and see aggregated engagement metrics, but they do not message users one-on-one through the platform, preserving user privacy and platform integrity.

Additionally, the present invention anticipates an AI-powered personal shopping assistant as a future-facing feature of the platform. In some embodiments, the system's processors implement an artificial intelligence module that learns from the user's browsing, following, and purchasing behavior to provide personalized assistance. This AI assistant can, for example, suggest products or businesses that align with the user's values (“You've shown interest in cruelty-free cosmetics; here's a brand that matches your criteria”). It can also provide spending guidance-analyzing the user's purchase history to inform them how much of their spending in the last month went toward their chosen causes, and offering recommendations to increase their impact. The AI may calculate or predict the social or environmental impact of the user's shopping choices (such as an estimate of carbon footprint saved by buying sustainable products). In some embodiments, the platform can be configured for automated transactions: the user can opt in to allow the AI assistant to automatically make certain purchases on their behalf. For example, a user might set a preference for the assistant to periodically buy household supplies from women-led suppliers when their stock is likely low, within a set budget. If those conditions are met, the system can initiate the purchase and notify the user-all while ensuring the chosen vendor aligns with the user's pre-specified values. Such automation is entirely optional and under user control, but provides a convenience factor and ensures that the user's spending consistently reflects their values without requiring constant manual input.

In further embodiments, the AI personal shopping assistant can manage event-based reminders and wish lists for the user's shopping: it can store upcoming important dates (such as birthdays or anniversaries) and proactively suggest suitable gift ideas from values-aligned businesses as those dates approach, and it can maintain a record of items the user intends to purchase in the future, later recalling these saved items to recommend ethically-aligned options or timely reminders. Furthermore, the assistant enables goal tracking by allowing the user to set personal goals for values-driven spending (for example, aiming to direct a certain percentage of monthly purchases to sustainable products), monitoring the user's progress and providing periodic reports or notifications that illustrate the user's performance relative to those goals and offer suggestions for improvement.

Overall, the invention provides a comprehensive platform that blends values-based data, social discovery, engagement rewards, AI-driven automation, and personal shopping assistance to facilitate a new kind of commerce experience. Consumers are empowered to make purchasing decisions that are in line with their principles, discover vetted businesses easily, and even delegate decisions to an AI aligned with their values. Businesses, in turn, gain access to a community of consumers who are actively seeking out and loyal to value-oriented brands. Additional features and advantages of the invention will be set forth in the following sections, and certain variations will be apparent to those skilled in the art upon reading the detailed description.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a block diagram illustrating the system architecture and main components of an exemplary value-driven commerce platform according to the present invention. It shows the interactions between client devices, the server, databases of profiles, and various software modules (such as the recommendation engine and AI assistant).

FIG. 2 is a flow diagram illustrating the user interaction steps and corresponding system processes of the platform. It depicts a consumer user discovering businesses based on values, following a business, and the system's handling of recommendations, notifications, and learning from the user's actions, including optional AI-driven automation.

FIG. 3A-L are diagrams of an example user interfaces of the value-driven commerce platform. It highlights different interface sections, including a user's profile with interests and badges, search and filter options for value-based discovery, a list of businesses with value badges that the user can browse or follow, an updates section providing cause-related notifications from friends or followed businesses, and settings where the user can adjust preferences (such as values or notification settings).

### DETAILED DESCRIPTION

In the following detailed description of the preferred embodiments, reference is made to the accompanying drawings, which form a part of this disclosure and illustrate specific examples of how the invention may be implemented. It is to be understood that other embodiments may be utilized and structural or logical changes may be made without departing from the scope of the invention. The detailed description is therefore not to be taken in a limiting sense, and the scope of the present invention is defined by the appended claims and their equivalents.

Various embodiments of the present system and method will now be described to enable those skilled in the art to practice the invention. It will be understood that certain routine elements or steps may be omitted for clarity, and that different combinations or orders of features are possible without deviating from the spirit of the invention. Throughout the description, like reference numbers may be used to refer to like elements in the drawings. Accordingly, those who work in the art will recognize that many modifications and adaptations to the present disclosure are possible and can even be desirable in certain circumstances and are a part of the present disclosure. Thus, the following description is provided as illustrative of the principles of the present invention and not in limitation thereof. The terms “a” and “an,” “the,” and similar references used in the context of describing an embodiment (especially in the context of certain claims) are construed to cover both the singular and the plural. The recitation of ranges of values herein is merely intended to serve as a shorthand for referring individually to each separate value falling within the range. Unless otherwise indicated, each individual value is incorporated into the specification as if it were individually recited herein. All steps or components described herein can be performed or arranged in any suitable order unless otherwise indicated or clearly contradicted by context. The use of any and all examples, or exemplary language (e.g., “such as”) with respect to certain embodiments herein is intended to better illuminate the invention and does not pose a limitation on the scope of the invention. No language in the specification should be construed as indicating any non-claimed element as essential to the practice of the invention. As used herein, the terms “optional” or “optionally” mean that the described event or circumstance may or may not occur, and that the description includes instances where the event or circumstance occurs and instances where it does not. Conditional language such as “can,” “could,” “might,” or “may,” unless specifically stated otherwise, is generally intended to convey that certain embodiments include, while other embodiments do not include, certain features or steps. Thus, such conditional language is not intended to imply that features or steps are required for one or more particular embodiments or that one or more particular embodiments necessarily include logic for deciding, with or without user input or prompting, whether these features or steps are included or performed. The word “or” as used herein means any one member of a particular list and also includes any combination of members of that list.

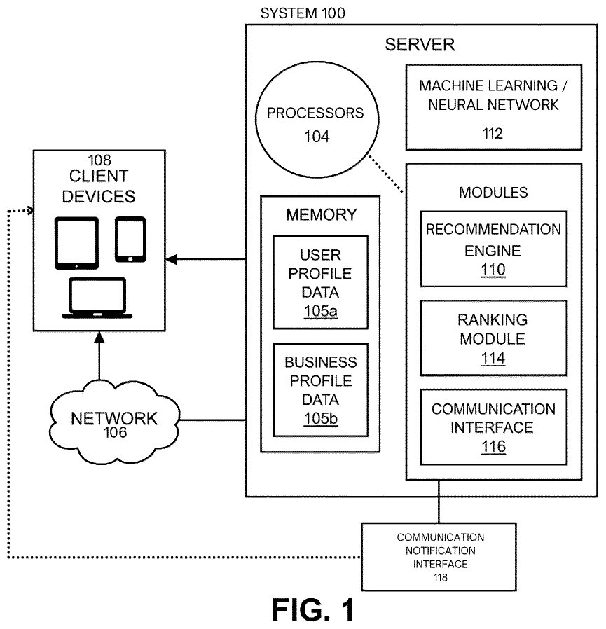

System Architecture (FIG. 1): As shown in FIG. 1, the platform is implemented via a system 100 that includes a server 102 (or a distributed set of servers in the cloud) connected to one or more client devices 108 via a network 106. The client device 108 can be, for example, a user's smartphone running a mobile application, a personal computer accessing a web interface, or any computing device that allows the user to interact with the platform. The network 106 may be the Internet, and communication can occur over secure channels (e.g., HTTPS or other encrypted protocols) to protect user data.

The server 102 comprises one or more processors 104 and a memory device 105 (which may include databases or other data storage mechanisms). The memory 105 stores the data and software modules that enable the platform's functionality. In particular, user profile data 105a and business profile data 105b are stored in the memory. The user profile data includes information such as each user's name or identifier, their stated interests and causes, connected friends (social graph), engagement history (e.g., which businesses they have followed or badges earned), and account settings. The business profile data includes each business's details: business name, category/industry, website, description, and claimed value-based attributes (for example, ownership demographics or sustainability certifications, charity affiliations). In some embodiments, the memory 105 also stores verification data or flags for those attributes that have been confirmed (for instance, a boolean or certificate indicating a “verified” status for a claim like women-owned or Certified B-Corp). Both types of profiles may further include multimedia (logos, images) and metrics (such as a business's rating or number of followers, or a user's impact statistics).

Illustrated in FIG. 1 are various software modules executed by the processors 104 to provide the platform's functionality. These modules may be implemented as distinct components or as integrated functions within the server's application. One key component is the recommendation engine 110, which is responsible for analyzing user data and business data to identify relevant business recommendations for a given user. In one embodiment, the recommendation engine 110 incorporates a machine learning model 112 (such as a neural network or other AI model) that has been trained on historical interaction data (e.g., past follows, user click-throughs, purchases, and feedback) to predict which businesses a user is most likely to value or engage with. The machine learning model 112 can take into account numerous factors, including how closely a business's profile matches the user's stated preferences, the user's past behavior on the platform, and even aggregate trends (for example, businesses that are popular among users with similar profiles or among the user's friends). The model is configured to continuously improve over time; as the system gathers more data on user interactions, the model 112 is updated based on user feedback and behavior to refine its recommendations. User feedback may be explicit (such as a user indicating likes/dislikes or confirming a purchase with a particular company) or implicit (such as the user's dwell time on a business profile, follow/unfollow actions, or purchase conversion rates). The processors 104 monitor these signals and use them as additional training data to periodically retrain or adjust the model 112, thereby learning to provide more accurate and meaningful suggestions with each iteration.

A ranking module 114 works in tandem with the recommendation engine 110. Module 114 takes the set of candidate businesses for a user (as identified by engine 110 or by search filters) and orders or filters them according to relevance and context. For example, module 114 may prioritize businesses with higher alignment scores (as computed by model 112). It can also apply secondary criteria, such as location proximity or category preferences if the user's query or profile specifies those (e.g., showing local businesses first, or highlighting “Made in America” brands first for a user interested in domestic products). The output of module 114 is typically a curated list of businesses or cause-related content that will be presented to the user. This module ensures that the most value-compatible businesses appear prominently for the user, increasing trust that the suggestions truly match the user's values.

The user interface module 116 generates the front-end views and interactive elements that the user sees on their client device 108. This module assembles data into user-friendly formats—for instance, creating the cards or entries for each recommended business with the business's name, logo, and value badges to be displayed in the mobile app. It also handles input forms and profile pages, such as the interfaces for users to select their interests or for businesses to enter their information. The user interface module 116 communicates with the client devices using standard web or app technologies (for example, sending structured data via RESTful APIs or WebSocket connections that the client app renders into the UI). Through the UI module 116, users can navigate the platform, perform searches, follow or unfollow businesses, view personalized content, etc., with the backend logic abstracted away.

The system 100 further includes a communication notification interface 118 that manages communications such as notifications and requests. In the context of the present invention, the communication notification interface 118 is utilized for actions like sending notifications to users about new content (for example, a push notification that a followed business just posted a deal), sending friend requests or follow confirmations, and similar messaging that originates from the system. The platform notably does not support open-ended direct messaging between users or between users and businesses, distinguishing it from typical social networks. Instead, the communication notification interface 118 is configured for structured, platform-mediated messages—for example, it will deliver a friend invite or an event notification, but users won't be composing free-form messages to each other. This design choice maintains the focus on commerce and values-oriented content, and helps prevent spam or unwanted solicitations. The communication notification interface 118 may use email, push notifications, or in-app notifications to relay information. For example, if user A sends a friend request to user B, interface 118 ensures user B receives an alert (or email) about it. If a business that user B follows publishes a new “sustainable product launch” announcement, interface 118 might trigger a push notification on user B's device. All such communication preferences can be adjusted by the user in their settings via the UI module 116.

In some embodiments, additional modules or services may be integrated into system 100. For instance, an attribute verification module (not explicitly shown in FIG. 1) could be present to handle the process of validating business claims. This module might interface with third-party databases or require documentation from business owners to confirm attributes like women-led or carbon-neutral certified status. Upon verification, the business profile in memory 105 is updated with a verified indicator, and the UI module 116 will display a special badge (e.g., a checkmark or shield icon) next to that attribute on the business's profile as visible to users.

Overall, the architecture of FIG. 1 supports a robust platform where data flows from users and businesses into stored profiles, and from stored profiles through intelligent modules 110/112/114 back out to users in the form of personalized content. The processors 104 continuously monitor and learn from user interactions on the platform (such as which recommendations are followed or ignored, which offers are redeemed), and these interactions are fed back into the cycle to improve the model 112 and adjust future recommendations. Thus, the more the platform is used, the smarter and more tailored the suggestions become, creating a virtuous cycle of engagement.

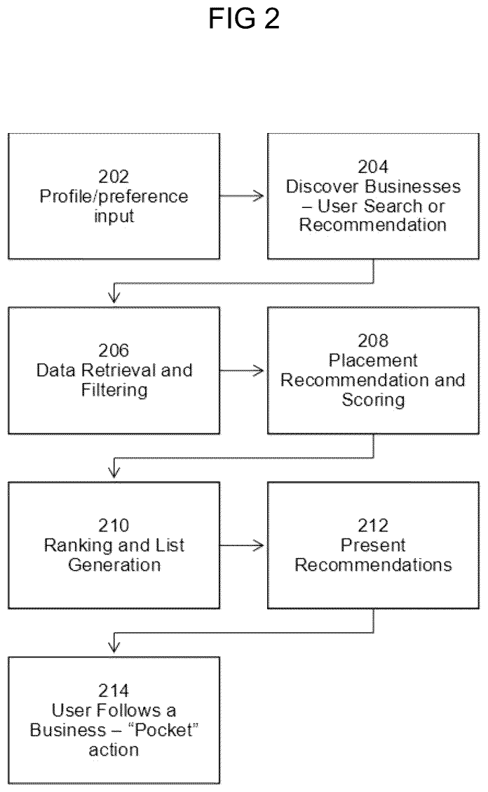

User Interaction Flow (FIG. 2): FIG. 2 is a flow diagram that illustrates an example sequence of interactions between a consumer user and the system, along with the system's internal processes at each step. This diagram demonstrates how a user might discover a business aligned with their values and how the platform responds at each step. It should be understood that FIG. 2 represents one embodiment, and that variations are possible (for example, a user could also discover businesses via system-generated recommendations rather than through an explicit search, but the underlying processes would be similar).

Before the flow begins, it is assumed that relevant business profiles have been created on the platform (e.g., businesses have signed up and entered their information) and that the user has an account or is in the process of creating one. Business onboarding might involve steps where a business owner inputs their company's details and value attributes, and possibly undergoes verification for certain claims—those preparatory steps populate the database but are not explicitly shown in FIG. 2 for brevity. We begin the flow with the consumer user's perspective:

Step 202 (Profile/Preference Input): A user (consumer) accesses the platform (for instance, by opening the mobile app for the first time) and inputs personal preferences or creates their profile. In this step, the user may be presented with an onboarding interface to select causes or values they care about. For example, the user might choose interests such as environmental sustainability, women-owned businesses, or community impact. The user can also set certain parameters like their location (if they want to find local businesses) or connect the app to their social network to find friends already on the platform. Providing these preferences allows the system to tailor the experience. The user's input (interests, causes, etc.) is transmitted by the user interface 116 from the client device 108 to the server 102 via the network 106. The server stores this data in the user's profile record in memory 105. (If the user already has a profile from a previous session, this step 202 might involve updating preferences, or it may be bypassed if preferences are already set.)

Step 204 (Discover Businesses—User Search or Recommendation): The user initiates a discovery action. This could take the form of an explicit search query or simply opening a home or “discover” screen that immediately presents suggested businesses. In an explicit search scenario, the user enters specific criteria into the search section of the interface (e.g., typing “coffee shops near me” and applying a filter for “fair trade”). In an automatic suggestion scenario, the app might proactively request or retrieve recommendations based on the user's stored interests (for example, showing “Suggested for you” businesses as soon as the user opens the app, without the user having to input a query). In either case, the user's request (which may include search keywords, selected filters, or cause tags) is sent from the client interface to the server 102 through the network 106. This communication can use an API call that includes the user's ID and query parameters. Upon receiving the request, the server 102 determines that it needs to provide a list of businesses matching the query and/or the user's profile.

Step 206 (Data Retrieval and Filtering): In response to the user's request, the server 102 retrieves data from memory 105. The processors 104 query the stored business profiles (in database 105b) to find candidate businesses that meet the criteria. For a search request, this means applying the search keywords and any selected filters to the database (e.g., finding all businesses tagged as coffee shops near the user's location and marked with “fair trade”). For a recommendation (no explicit query) scenario, this retrieval may simply pull a broad set of businesses relevant to the user's interests, their friends'interests, or general popularity on the platform. The result of this retrieval is a preliminary set of candidate businesses that potentially match the user's request or profile. The processors 104 may then apply preliminary filtering, removing any results that clearly do not align with the user's stated values or preferences. This yields a candidate list of businesses for further evaluation by the recommendation algorithms.

Step 208 (Recommendation and Scoring): The processors 104 now execute the matching/recommendation algorithm on the candidate list. The matching score calculation (performed by the recommendation engine 110 using the machine learning model 112) assesses each candidate business relative to the specific user. The system evaluates multiple features, such as how well each business's attributes align with the user's values (for instance, if the user cares about eco-friendliness, businesses with “sustainable” attributes score higher), the business's overall quality or rating, and the user's past interactions (if any) with similar businesses. The machine learning model 112 computes a relevance or alignment score for each candidate business. These scores indicate the predicted level of compatibility or interest for the user. In some embodiments, the model also accounts for social factors (for example, boosting the score of a business that many of the user's friends follow). The output of this step is a set of scored candidates.

Step 210 (Ranking and List Generation): The system then generates a ranked list of recommended businesses for the user. The ranking module 114 sorts the candidate businesses based on their scores from step 208, typically ordering them from highest to lowest relevance. The module 114 can also incorporate any necessary filtering or diversification at this stage. For example, if two businesses are very similar, the system might only show one of them to give variety, or it might ensure that the top results are from different categories to avoid a monotonous list. The result of this step is a final list of recommended businesses tailored to the user's values and query (if any). This list is then prepared for presentation via the user interface.

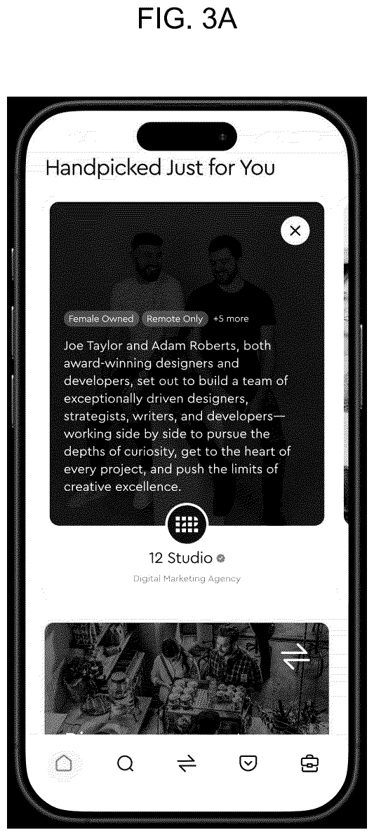

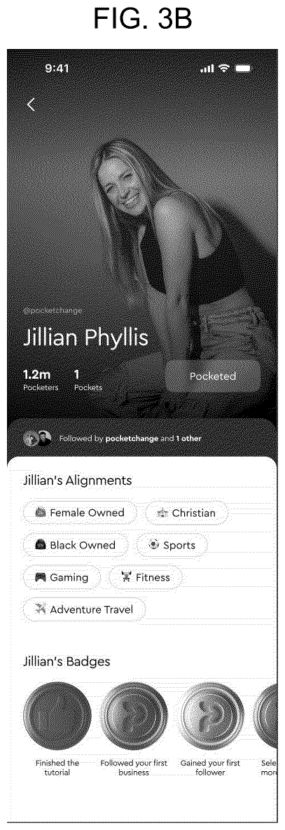

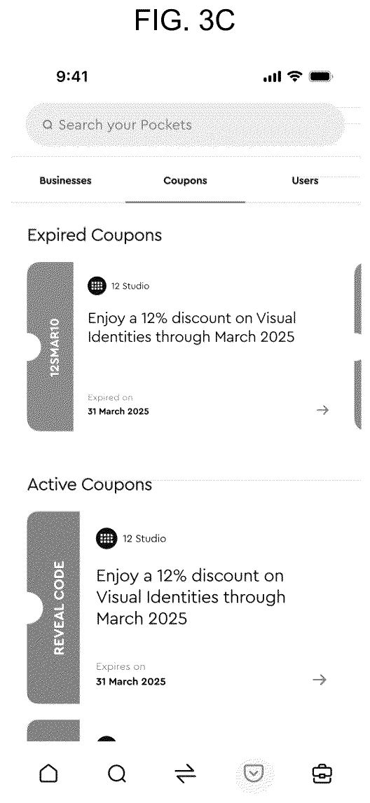

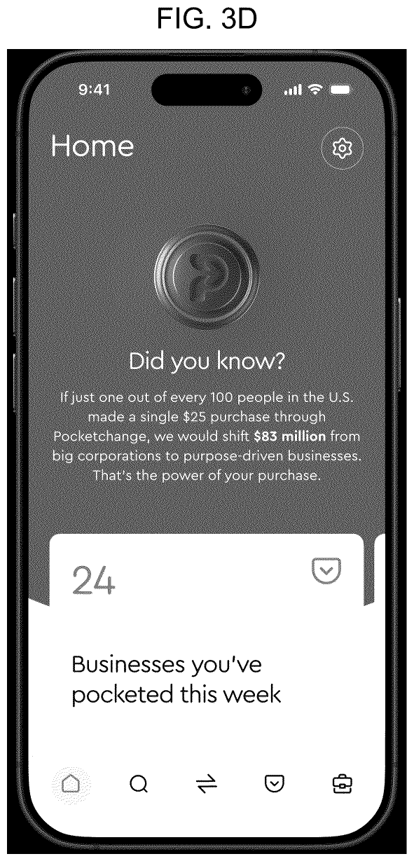

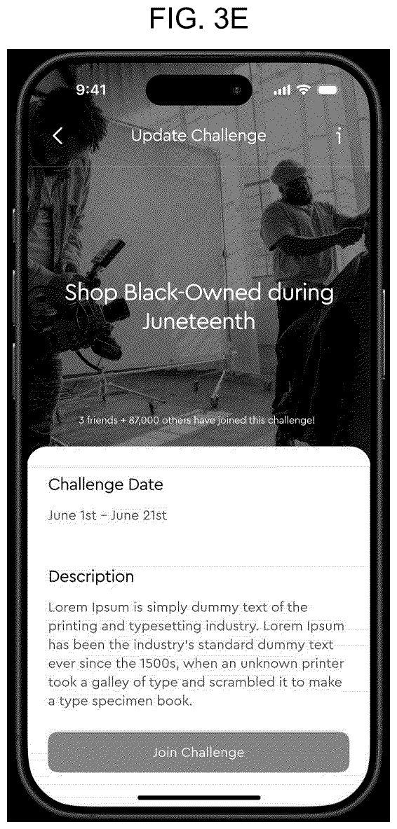

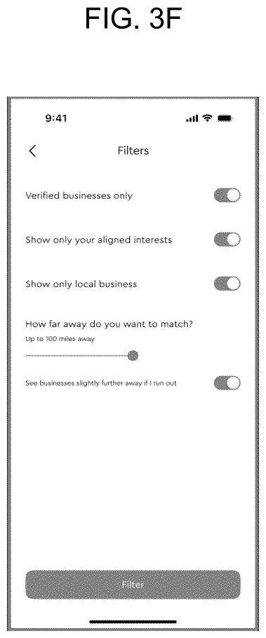

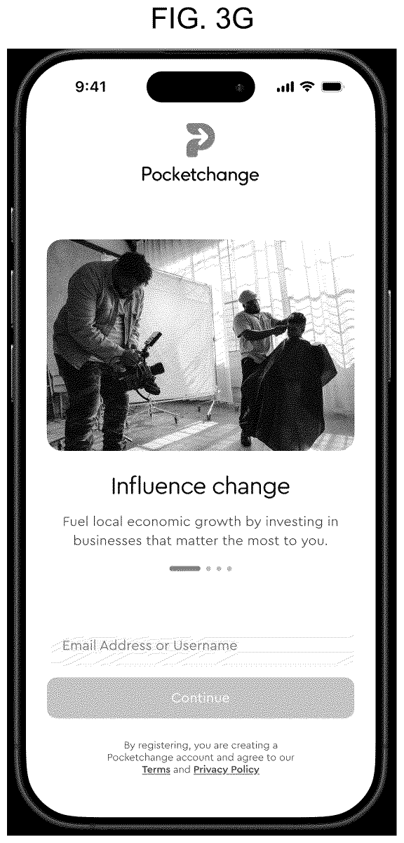

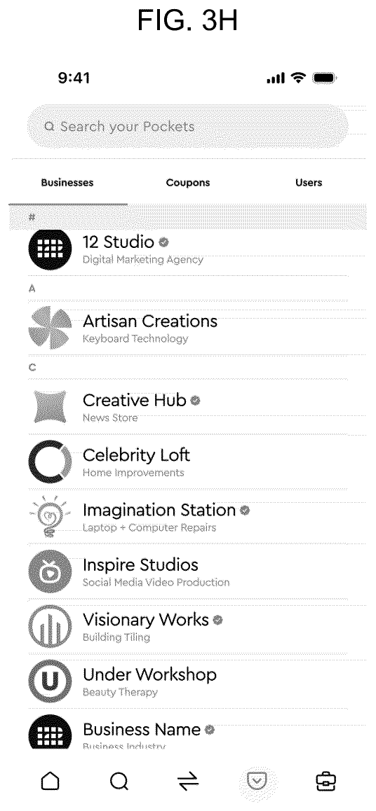

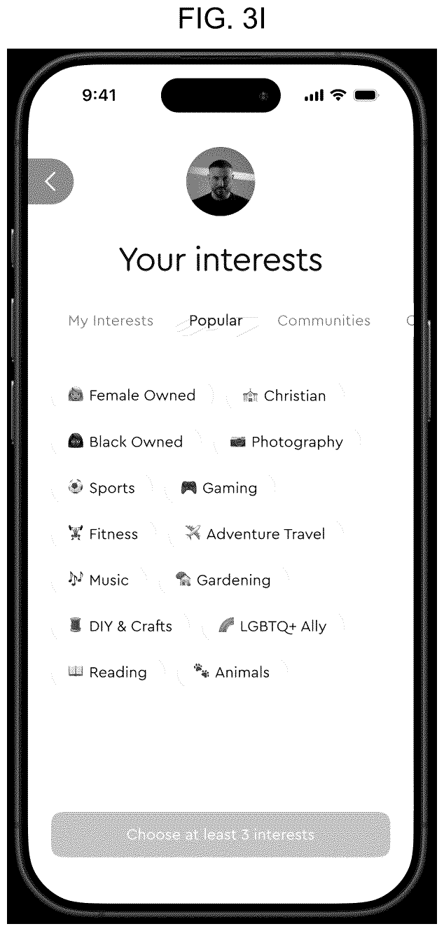

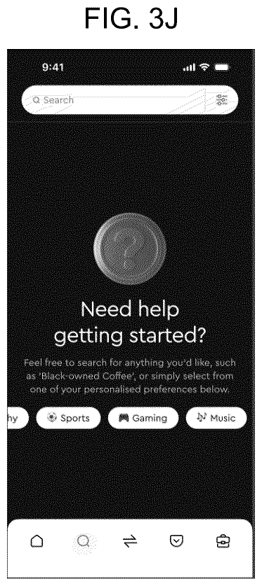

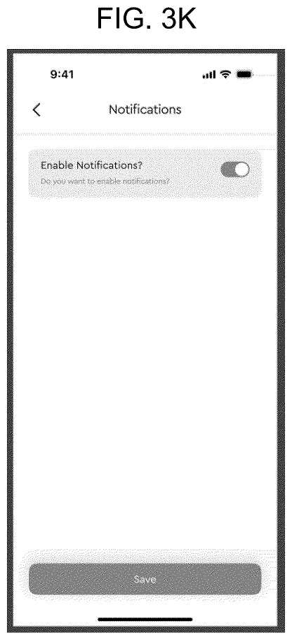

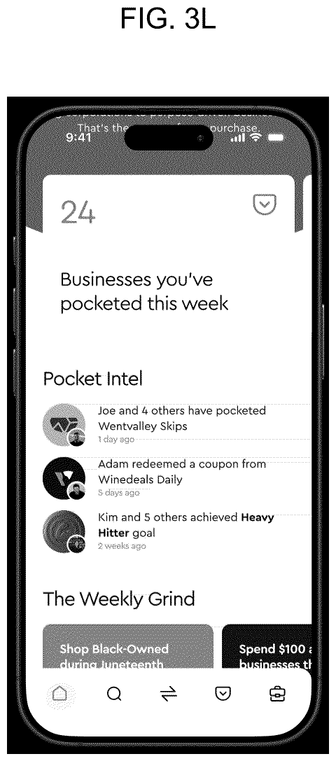

Step 212 (Present Recommendations): The user interface module 116 presents the ranked list of recommended businesses to the user on the client device 108. In the interface (as exemplified in FIG. 3), this list may appear as a series of business “cards” or entries, each displaying key information like the business's name, logo, a brief description, and icons or badges indicating the business's value-based attributes (and whether they are verified). The interface might also show an indicator of social proof (e.g., “3 friends follow this business”) to help build trust. At this stage, the user sees a personalized selection of businesses that align with their values and any search criteria they provided, all in a user-friendly format. The user can scroll through the list and select any business that interests them for more details.

Step 214 (User Follows a Business—“Pocket” action): After reviewing the recommendations, the user can choose to engage with a business that appeals to them. In this scenario, the user decides to “Pocket” (follow) a particular business from the list. For example, they tap a “+Pocket” or “Follow” button on the business's listing. The system records this action: the UI module 116 sends a follow request to the server 102, which then updates the memory 105 to associate the user's profile with the followed business's profile (creating a follower/followee relationship). The interface provides feedback to the user (the button may change state to indicate the business is now “Pocketed,” and perhaps a message like “You are now following [Business Name]” is displayed). Additionally, the platform can trigger a welcome notification or message—for instance, it might display, “Thank you for supporting this women-owned business! We'll keep you updated on their news and offers.” This confirms to the user that their follow action was successful and informs them of what to expect (updates from that business).

(Subsequent steps in the flow might include the user making a purchase or sharing the business with friends, but those are beyond the basic scope of discovering and following a business and may not be explicitly shown in FIG. 2. The important outcome of Step 214 is that the user's action (following a business) feeds back into the system's data: the user's profile now includes this connection, and the system will henceforth treat this as a signal for future recommendations and send related updates through the communication notification interface 118.)

User Interface and Features (FIG. 3A-L): FIG. 3A-L illustrate an example user interfaces of the platform, highlighting various interface sections and elements that enable the above-described functionality. The interface is typically presented in a mobile app or web dashboard and is organized into sections denoted by reference numerals, as follows:

Profile Section: As illustrated in FIG. 3, the user interface includes a profile section that displays information about the logged-in user. In the context of a consumer user, this section might show the user's name or handle, a profile photo, and summary stats or icons reflecting their engagement. For example, it could list the number of businesses the user follows, badges earned (such as “Local Supporter”), or causes of interest. This section serves as the user's personal dashboard, emphasizing their values and activity. It may also provide options to edit profile details or preferences.

Search/Discovery Section: FIG. 3 depicts a search or discovery interface section, which enables users to find businesses according to various criteria. This section typically includes a search bar where a user can type keywords (e.g., “bakery” or “vegan shoes”) and might also include filter options (such as location, industry, or specific value tags like “organic” or “fair trade”). In an exemplary embodiment, section might have a toggle between a “Search” mode and a “Discover” mode. In Search mode, the user's manual query drives the content, whereas in Discover mode, the system's recommendations (from module 114) are shown without the user entering a specific query (for instance, suggesting businesses based on the user's interests as soon as they open the app). When the user enters a query and submits it, section communicates that query to the backend processors 104 (as described in step 204 above). This section is designed to be user-friendly, possibly with auto-complete suggestions (e.g., as the user types, it may suggest popular cause tags or nearby businesses). If the user has not entered anything (and is in Discover mode), this section may trigger the retrieval of default recommendations (such as trending value-driven businesses or new additions to the platform).

Business Listing/Results Section: In FIG. 3, after performing a search or upon accessing the discovery interface (home screen), the main content area shows a list of business “cards”. (We may refer to the container of this list as section representing the results list, with each individual entry being a business card.) Each business card is an element representing a recommended or searched-for business, displaying key information such as the business name, logo, industry/category, location, and perhaps a brief tagline or description. The card also shows relevant value attributes (e.g., icons or text like “Women-Owned” or “Carbon Neutral”) and any verification badge for those attributes. If social proof is available, it might show an indicator like “5 friends support this” or a star rating. In the depicted interface of FIG. 3, users can scroll through these cards vertically. The cards are interactive; when a user taps or clicks a card, the interface brings up more detailed information about that business (transitioning to the Business Detail section). This list section serves as the core browsing area where users review their matches or search results.

Business Detail Section: Illustrated in FIG. 3, when a user selects a specific business (either by clicking a card or a “View Details” link), the UI transitions to a business detail section. This section provides a comprehensive view of the business's profile. It may occupy the full screen or appear as a scrollable page/modal. The detail section includes elements such as: a larger business description (detailing what the business offers, its mission statement, ownership, leadership, etc.), a detailed list of the business's value tags/badges (for instance, an icon with text “Certified B Corporation-Verified”), and possibly user-generated content like ratings or reviews if the platform allows users to rate businesses (the invention could include a simple rating system to further build trust and feedback, though it is not required). Prominently, this section includes a follow (“Pocket”) button if the user isn't already following this business. In FIG. 3, this might be shown as a button labeled “+Pocket” or “Follow,” which toggles to a different state (e.g., “✓ Pocketed”) once clicked, indicating the follow status. There may also be a “Share” option to share the business profile externally or invite others to view it. If the business has any current promotions or upcoming events, those could be listed here as well. Contact information or a link to the business's website might be provided (for example, a “Shop now” button that leads to an external site if transactions aren't handled within the platform). The design of section aims to give the user enough information to decide if they align with and want to support this business. All key points reflecting values (owner demographics, sustainability practices, community initiatives, etc.) are highlighted. The user can scroll through this information and then hit the follow button to add the business to their Pocket list.

Social Updates Section: FIG. 3 includes a section that provides a stream of value-related social updates. In one embodiment, section is a dedicated part of the interface (such as a tab or a panel on the home screen) where the user sees updates tied to their social connections and causes. For example, entries in this section might include: “Your friend Alex just followed GreenEarth Grocers (a sustainable supermarket),” “BrightTech (a business you follow) achieved a new sustainability certification!”, or “Cause Spotlight: Ocean Cleanup Initiative—50 businesses you follow are contributing this month.” Each update item can be interactive; selecting a friend-related update might show more about that friend's profile or the business they followed, while selecting a cause spotlight might show related businesses or a way to participate. This updates section keeps users engaged and informed about both their network and the causes they care about. Importantly, because there is no direct messaging on the platform, section (along with the notifications handled by communication notification interface 118) is a primary way users receive information about their friends'activities and value-related news on the platform. It encourages a sense of community (“others are also supporting what I care about”) without requiring private chats, thereby maintaining focus on value-centric content. (In a purely business-networking oriented embodiment of the invention, a similar interface region might instead show a network graph of business-to-business connections; however, in this consumer-centric embodiment, that is replaced by the social updates stream described above.)

Settings/Preferences Section: Depicted in FIG. 3 is a settings section, typically accessible via a menu or a dedicated tab. In the settings section, users can fine-tune various aspects of their platform experience. Key preferences that can be adjusted here include: the user's values and causes (they can update which causes or attributes are most important to them, which will influence recommendations), notification preferences (choosing what kinds of notifications to receive, such as toggling off push notifications for new friend activities while keeping those for new business offers), privacy controls (options to make their profile or activity visible only to friends or to the public, as desired), and AI assistant settings (if a personal shopping assistant feature is available, this is where the user manages it—e.g., viewing or altering any active automated purchase rules the user has set). Additional configuration options in this settings section may support the AI's proactive shopping features—for example, the user could input upcoming special events or dates for which they want gift suggestions, or maintain a list of “planned purchases” items that they intend to buy eventually. The user can also set or modify their values-based spending goals in this section (e.g., specifying a target percentage of purchases to be sustainable or local), which the AI assistant will then track and use in providing feedback and recommendations. By adjusting these settings, the user can personalize the matchmaking results and overall experience to better suit their needs and preferences. The settings section communicates with the processors 104 to store the user's preferences in memory 105 and update the various modules (like the recommendation model 112 or communication notification interface 118) accordingly.

As users interact with the user interface, the processors 104 continually monitor their interactions and transactions, using this data to refine the recommendation model 112. For example, the system tracks which suggested businesses a user follows, which ones they ignore, and any subsequent purchases or engagements. This ongoing feedback allows the platform to improve the accuracy of future compatibility scores and recommendations over time. The user interface, through elements like the follow buttons and settings, actively involves the user in curating their experience, while the backend learns from the user's behavior. In this way, the platform dynamically adapts to the user's evolving preferences. For example, the assistant can manage personal event reminders and wish lists to further aid the user. It may store in memory 105 a list of upcoming important dates for the user or their close contacts (such as birthdays, anniversaries, or holidays) and, as each date approaches, automatically generate a notification or suggestion through the user interface with one or more gift ideas from businesses that align with the user's values (or the intended recipient's interests). Likewise, the assistant can maintain a “planned purchases” list by recording items that the user has expressed intent to buy in the future; at an appropriate time (for instance, upon user request or when a relevant context arises), the system will remind the user about the item and recommend value-aligned options for purchasing it. Another advanced feature of the AI assistant is shopping goal tracking. The user can define specific values-based shopping goals (for example, allocating a certain portion of their monthly spending to minority-owned businesses or reducing spending on non-sustainable products). The assistant monitors the user's transactions and engagements over time relative to these goals, and periodically generates progress reports or feedback notifications. These reports, viewable via the user interface 300 or delivered as summaries, inform the user how they are performing against their goals (e.g., “You've met 40% of your sustainable spending target this month”) and may offer suggestions to help the user reach or exceed their objectives. Through such tracking and feedback, the platform actively supports users in improving their values-aligned consumption habits over the long term.

The foregoing detailed description of the UI and flow is intended to illustrate how the components operate together to realize the invention's objectives. It will be apparent to those skilled in the art that various changes in form and detail can be made—for instance, additional UI sections could be added, or certain features (like social updates) could be omitted in a simplified embodiment—without departing from the scope of the invention. The scope of the invention, therefore, is defined by the following claims.

What is claimed is:

1. A computer-implemented method for facilitating value-driven commerce and social shopping based on personal values, the method comprising: storing, in a computer memory device, a plurality of user profiles and a plurality of business profiles, wherein each user profile includes values preferences of a corresponding user and each business profile includes descriptive attributes and claimed value-based characteristics; determining, by one or more processors, a set of candidate businesses relevant to a target user based on the target user's values preferences and the business profiles; calculating, by the one or more processors, alignment scores for the candidate businesses with respect to the target user, using a machine learning model trained to predict compatibility between users and businesses based on historical interactions; generating a personalized list of recommended businesses for the target user, ordered according to the alignment scores; presenting the personalized list of recommended businesses to the target user via a user interface, each recommended business being displayed with information about its value-based characteristics and any verification indicators; receiving, through the user interface, a selection from the target user to follow a particular recommended business; and in response to the target user's selection, storing an association between the target user's profile and the particular business's profile to record that the target user follows the business.

2. The method of claim 1, wherein each business profile's descriptive attributes include at least one ownership demographic attribute or at least one ethical or sustainability attribute; and wherein the ownership demographic attribute is selected from the group consisting of women-owned business and minority-owned business, or the ethical or sustainability attribute is selected from the group consisting of environmentally sustainable practice, fair-trade certified status, carbon-neutral certification, and charitable-giving program.

3. The method of claim 1, further comprising displaying a verified badge or indicator alongside a value-based characteristic of a business profile on the user interface when that characteristic has been verified for authenticity, thereby building user trust that the business indeed meets the claimed value criteria.

4. The method of claim 1, further comprising awarding a user an incentive in response to the user engaging in a value-aligned shopping action, the incentive being one of: a digital badge added to the user's profile recognizing the user's support of a particular cause, or a discount or promotion provided to the user for a future purchase; wherein the shopping action is at least one of: following a business with a specified value attribute, making a purchase from a cause-supporting business through the platform, or reaching a spending milestone on products that meet the user's stated ethical criteria.

5. The method of claim 1, further comprising enabling social network connections between users of the platform, wherein a first user can send a friend request to a second user and, upon acceptance of the request, the first and second user become connected friends on the platform; and wherein the method includes presenting to the first user, via the user interface, updates that incorporate information about businesses and causes that the second user has engaged with, thereby facilitating discovery of value-aligned businesses through social influence without direct messaging between the users.

6. The method of claim 1, wherein the machine learning model used in calculating relevance scores is configured to continuously improve its recommendations by incorporating feedback from the target user's interactions, the method further comprising: tracking the target user's behavior with respect to the recommended businesses (including which businesses the user follows, ignores, or later makes purchases from) as implicit feedback; and updating the machine learning model's parameters based on said feedback, such that the model adjusts weighting of features to better predict the target user's preferences in future recommendation cycles.

7. The method of claim 1, further comprising analyzing the target user's spending behavior and purchase history on the platform to generate an impact report or guidance for the target user, the analyzing step including categorizing the target user's purchases by cause or value category (based on attributes of businesses from which purchases were made) and computing metrics indicative of the target user's values-based impact (including, for example, a percentage of the user's spending that went to sustainable products or minority-owned businesses over a given period), wherein the user interface presents these impact metrics to the target user and optionally suggests adjustments or new recommendations to help the target user increase alignment with their stated goals.

8. The method of claim 1, further comprising an automated transaction sub-process, wherein the platform, with prior authorization from the user, automatically initiates a purchase on behalf of the user when predetermined criteria are met, the sub-process including: predicting a user need or opportunity based on the user's preferences and past purchasing patterns; selecting a product or service from a business profile that aligns with the user's values to fulfill the predicted need; and executing a purchase order for the selected product or service using stored user payment information, if the user has opted in to an auto-purchase service and the criteria for that service (timing, spending limit, product type, etc.) are satisfied, thereby providing hands-free, values-aligned shopping for the user.

9. A system for facilitating value-driven commerce and social shopping based on personal values, the system comprising:
a memory device for storing profile data for a plurality of users and a plurality of businesses, the profile data including, for each user, user-specific values preferences and social connections, and for each business, descriptive attributes and claimed value-based characteristics;
one or more processors coupled to the memory device and configured to execute instructions for:
i. applying a recommendation model to the stored profile data to determine a set of recommended businesses for a given user, wherein applying the model includes analyzing the given user's values preferences in relation to the businesses'value-based characteristics and computing alignment scores indicative of how well each business matches the user's values;
ii. updating the recommendation model based on user interactions by monitoring the given user's engagement with presented recommendations and using the engagement data as feedback to refine the model for improved alignment accuracy in future recommendations;
iii. generating a ranked list of value-aligned recommended businesses for the given user based on the alignment scores, the list being filtered according to any user-specified criteria and prioritized such that businesses with higher alignment scores are ranked higher; and
a user interface operable on a client device for presenting the ranked list of recommended businesses to the given user, wherein the user interface displays, for each recommended business, information about the business's value-based characteristics along with any verification indicators or social proof of friend engagement, and allows the user to select an option to follow a recommended business.

10. The system of claim 9, wherein the memory device stores, for each business profile, a verification status for at least one value-based characteristic, but verification is not required for a business to claim a value-based attribute.

11. The system of claim 9, wherein the instructions further configure the one or more processors to: receive, via the user interface, an input from the given user indicating a selection to follow a particular recommended business; and store, in the memory device, data associating the user's profile with the particular business's profile as a follower relationship, such that the system will include the user in future communications or content updates from the particular business.

12. The system of claim 9, wherein the instructions further configure the one or more processors to manage user social connections by: receiving, via the user interface, a friend request initiated by a first user to connect with a second user on the platform; upon the second user's acceptance of the friend request, updating the profile data in the memory device to establish a social link between the first and second users; and subsequently adjusting content presented to the first user to include activity or recommendations influenced by the second user's engagements (including businesses the second user follows or endorses), thereby leveraging the social connection to enhance values-based discovery.

13. The system of claim 9, wherein the instructions further configure the one or more processors to monitor a user's transactions or purchase activities made through or tracked by the platform, and to trigger a reward mechanism when a predefined criteria is met, the reward mechanism including updating the user's profile to reflect a newly earned badge or sending the user a promotional incentive, wherein the predefined criteria is tied to values-based commerce behavior by the user selected from: making a purchase from a business with a particular verified attribute, reaching a threshold amount of spending on cause-related products, or consistently engaging over time with businesses supporting a specific cause.

14. The system of claim 9, wherein the instructions further configure the one or more processors to automatically initiate a purchase transaction on behalf of the given user in accordance with user-defined automation preferences, the automatic initiation comprising: identifying a product or service that the user has authorized for automatic purchasing (including identifying a values-aligned business offering said product or service); determining that conditions for automatic purchase are satisfied based on the user's usage data or schedule (including, for example, time elapsed since last purchase or an inventory depletion signal); and executing the transaction through a secure communication with a vendor system or payment gateway, wherein the user interface provides a notification to the user of the automated purchase and allows the user to cancel or modify future automated purchase settings.

15. The system of claim 9, wherein the user interface is further configured to present to the given user a customizable display of content that combines recommended businesses with cause-related updates, including updates from businesses the user follows and highlights of the user's friends'activities on the platform, the content being generated by the one or more processors taking into account both alignment with the given user's values and social relevance from the user's connections, such that the given user receives a curated stream of value-driven commerce information without enabling direct messaging between users.

16. The system of claim 9, wherein the instructions further configure the one or more processors to manage event-based reminders and gift planning by: storing, in the memory device, data representing upcoming personal events associated with the given user or the user's social contacts; and automatically generating, prior to an upcoming event date, a notification or suggestion via the user interface that recommends one or more potential gift items from businesses aligned with the given user's values or with an intended recipient's preferences.

17. The system of claim 9, wherein the instructions further configure the one or more processors to provide a shopping list memory and smart recall function by: receiving, via the user interface, an input from the given user specifying an item or service intended for future purchase; storing the specified intended purchase in the memory device in association with the given user's profile; and upon detecting a predetermined trigger condition, retrieving the stored intended purchase and presenting the given user with a reminder or recommendation to purchase the item, including suggesting a values-aligned business from which to make the purchase.

18. The system of claim 9, wherein the instructions further configure the one or more processors to enable values-based shopping goal tracking for the given user by: providing an interface for the given user to define one or more spending goals related to supporting selected values or causes; monitoring the given user's transaction data on the platform with respect to the defined goals; and periodically generating, via the user interface, a progress update or report indicating the given user's performance relative to each defined goal and including suggestions or recommended actions to help the given user achieve the goals.
